(19) United States
(12) Patent Application Publication
(10) Pub. No.: US 2019/0224790 A1
(43) Pub. Date: Jul. 25, 2019

(54) VARIABLE MACHINE TABLE

(71) Applicant: HOMAG Bohrsysteme GmbH, Herzebrock-Clarholz (DE)

(72) Inventors: Thomas BETTERMANN, Bielefeld (DE); Frank WEGENER, Leipzig (DE); Dennis BURSCH, Bornheim (DE)

(21) Appl. No.: 16/330,758

(22) PCT Filed: Aug. 28, 2017
(86) PCT No.: PCT/EP2017/071524

§ 371 Date: Mar. 5, 2019

(30) Foreign Application Priority Data
Sep. 7, 2016 (DE) 10 2016 217 003.1

(51) Int. Cl. B23Q 1/03; B25B 11/00; B23Q 3/06

(52) U.S. Cl. CPC B23Q 1/035; B23Q 3/088; B23Q 3/062; B25B 11/005

(57) ABSTRACT

The invention relates to a machine table for a machine tool. Such machine tools are used, for example, in the wood-processing industry. The machine table comprises clamping elements, each of which has a clamping device, wherein, starting from a receiving position, the clamping elements can be raised to a raised position and lowered to a lowered position relative to a reference element.

### TECHNICAL FIELD

The present invention relates to a machining table for a machining device. Purely by way of example, such types of machining devices are used in the field of the wood processing industry.

### PRIOR ART

One example of a known machine concept are machines having so-called consoles, with suction devices being used to mount workpieces on said consoles. One advantage of such a machine having consoles is that it is thereby possible to machine edges and end faces, and the clamping means can be moved in the X-Y plane. Due to the workpieces being mounted on the consoles, a comparatively small vacuum power is necessary.

One significant disadvantage of the console machines are the relatively high acquisition costs. Furthermore, a machining in the so-called nesting method, in which partial workpieces are separated from a plate-shaped initial workpiece, is only possible with a large effort and with additional measures.

In one other embodiment, the machining tables are formed as so-called vacuum flat tables. In particular, these make the nesting machining possible. Furthermore, a comparatively simple assembly with large plate-shaped workpieces is possible. In addition to comparatively low acquisition costs, a simple cleaning of the vacuum flat table constitutes a further advantage.

However, these advantages are contradicted inter alia by the fact that a comparatively high vacuum power is necessary in order to clamp workpieces with sufficient holding force. In particular, a sacrificial plate is required for a nesting machining. A free movement of the clamping means can also only be made possible with additional modules.

Furthermore, document EP 1 997 582 A1 is known which relates to a method for calibrating a clamping table. The aforementioned clamping table consists of a plurality of transverse traverses, each of which holds a plurality of pairs of clamping elements inserted next to one another. At its lower end, the clamping elements are mounted on further traverses which extend parallel to the aforementioned traverses. Each clamping element substantially consists of a telescopic tube unit, a suction pad and a positioning drive in the form of a stepper motor.

When a plate-shaped workpiece is placed on the clamping table, clamping elements with their suction pads are in a completely retracted (lowered) state. The workpiece rests on balls of the supports and can be aligned in this manner, in particular pushed against stops. Then, those clamping units which would not hinder the later machining of the workpiece owing to their extension are activated. They are selected by control in the general program; this occurs by controlling the relevant stepper motors. The inner telescopic tubes of the relevant clamping elements are thereby extended with the help of the spindle drive and evenly lift the workpiece from the supports. As soon as the inlet bore passes through the seal, a negative pressure is applied to the suction pads, so that they clamp the workpiece.

### SUBJECT MATTER OF THE INVENTION

The goal of the present invention is to increase the variability of a machining table over the prior art.

Claim 1 provides a solution for this. Furthermore, the invention relates to a machining device according to claim 13 as well as a method according to claim 14. Further preferred embodiments are specified in the dependent claims, with the subject matter of the dependent claims which relate to the device(s) being able to be used within the scope of the method, and vice versa.

The present invention provides a machining table for a machining device, having: a reference element, for example a cover plate or a reference element, and several clamping elements which each have a clamping device, in particular a suction pad, with the clamping elements being able to be raised and lowered starting from a receiving position relative to the reference element. It is thereby preferred that the clamping elements can be adjusted in a vertical direction.

The receiving position is an initial or rest position of the clamping elements. In one preferred variant, all clamping elements are in the receiving position when starting up the machining table. Moreover, it can be provided in a further preferred variant that all clamping elements return to the receiving position when the machining table is switched off.

It is possible by means of the machining table according to the invention inter alia to unify the machine variants for flat-table machines and console machines into one concept, and consequently, to considerably increase the variability.

In particular, milling without a protective plate is possible since the clamping elements can be lowered starting from a receiving position.

Furthermore, a five-sided machining, optionally partially without reclamping, can occur directly after a nesting machining.

According to a preferred embodiment, it is possible to provide stops for workpieces in a predetermined grid (for example 50×50 mm) on the table.

Furthermore, compressed air, which according to one embodiment can flow through the table from below, can be used to clean the table and can be used so that the, in particular plate-shaped, workpieces are able to be used on an air cushion with little force.

Since—according to one preferred embodiment—the controller knows the parts to be machined, it is possible to specify the optimum clamping situation in which the correct segments are lifted (raised), and thus a simplified loading of the machine is possible.

According to one embodiment, it is possible to support the (for example, upper or lateral) extraction of the chips by means of compressed air from below.

It is preferred within the scope of the invention that the clamping elements are individually controllable in order to carry out an adjustment movement of the clamping element, preferably in a vertical direction, relative to the reference element. In this manner, a high flexibility is made possible.

It is further preferred that a drive is provided for each clamping element in order to carry out an adjustment movement of the clamping element, preferably in a vertical direction, relative to the reference element. Consequently, a high variability is ensured. One embodiment is infinitely adjustable.

It is provided within the scope of one embodiment that the suction pad of the clamping element is held by a, preferably tubular, support element, with the support element extending through an opening in the reference element (for example, cover plate) of the machining table. In this manner, a constructive comparatively simple configuration can be provided.

Furthermore, it is preferred that the support element has a projection. The projection can be provided as an area having an enlarged diameter. Moreover, the projection in a raised position of the clamping element can be moved against a stop of a holding frame of the machining table and/or the projection in a lowered position of the clamping element can be moved to or on an upper side of a first section of a holding frame of the machining table. It is thereby further preferred that the holding frame is arranged in a vertical direction beneath the reference element (for example, cover plate).

According to one preferred embodiment, a locking mechanism can be provided for each clamping element in order to lock the respective clamping element into a raised position. Consequently, a secure holding of a workpiece in a raised position of the respective clamping element can be ensured.

In a further modification, it is preferred that a negative pressure source or a negative pressure connection and a compressed air source or a compressed air connection are provided which are correspondingly connected with a negative pressure channel or a compressed air channel of a clamping element. In the case of a negative pressure source and a compressed air source, these can be thereby integrated into the machining table.

In this sense, “air” means any type of gaseous liquid.

A negative pressure (vacuum) is used in order to clamp a workpiece to a respective suction pad. By contrast, compressed air is used inter alia in order to facilitate a cleaning process and/or to securely remove a workpiece from a suction pad.

It is further preferred that the clamping elements are arranged matrix-like in a plan view of the machining table. Consequently, a high flexibility is ensured after clamping elements have been provided in the longitudinal direction as well as in the width direction of the machining table.

According to a further embodiment, it is preferred that above the clamping elements a sheet is provided, which has openings in the area of the clamping devices. Consequently, it can be prevented that chips move into areas (interspace) between the clamping elements.

According to one further embodiment, the machining table further comprises at least one clamping unit which is preferably mounted on a clamping device, in particular a suction pad, of a clamping element. The clamping unit can be connected with the clamping element in such a manner that an actuation of the clamping device causes an actuation of the clamping unit.

According to a further embodiment, the clamping unit works in conjunction with a clamping device in order to hold a workpiece.

Moreover, the present invention relates to a machining device which shows a machining table according to one of the preceding aspects.

The machining device comprises one of more machining aggregates. The machining aggregate can be a milling aggregate, a drilling aggregate, a printer, such as for example a printer for an additive process (so-called 3D printer), etc.

### BRIEF DESCRIPTION OF THE DRAWINGS

FIG. 1 shows a perspective view of a preferred embodiment of the present invention.

FIGS. 2a and 2b show a machining in which the partial workpieces are separated from an initial workpiece.

FIGS. 3a and 3b show method states in which partial workpieces are machined and a remaining workpiece is conveyed away.

FIG. 4 is a schematic detailed view of two clamping elements.

FIG. 5 shows a further preferred embodiment of the present invention.

### DETAILED DESCRIPTION OF THE PREFERRED EMBODIMENTS

Preferred embodiments of the present invention are explained below in detail by means of the enclosed figures. Further modifications of certain individual features cited in this context can each be combined with one another in order to form new embodiments.

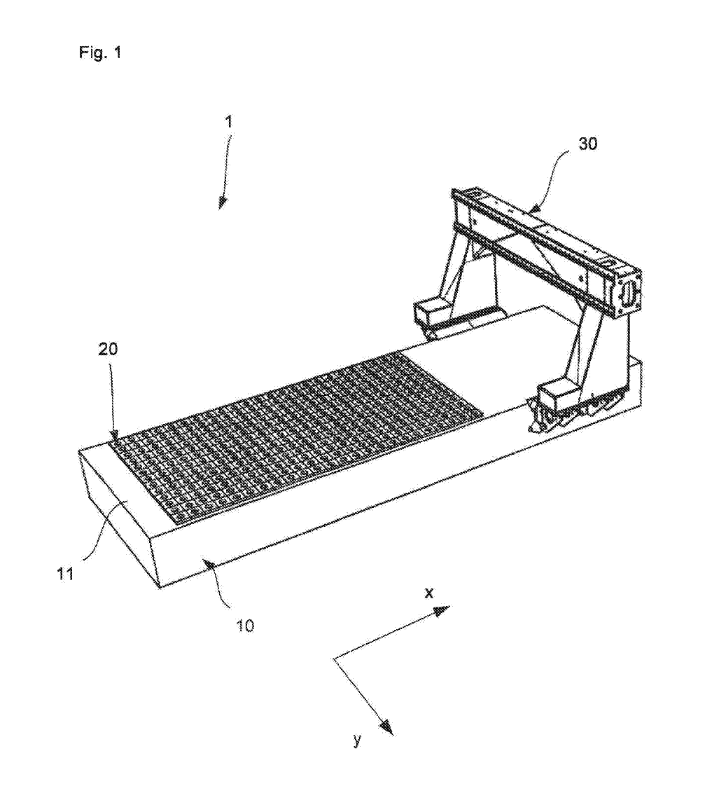

In FIG. 1, a machining device 1 is shown which comprises a machining table (machining bed) 10. Within the scope of the described, preferred embodiment, it is a wood machining device with which the preferably plate-shaped workpieces of, for example, wood, wood materials, composite material, or the like can be machined.

A portal 30 is movable along the machining table 10. The portal can accommodate, for example, a machining aggregate (not shown) which is movable along the portal 30. For example, the machining aggregate can accommodate a milling cutter, a saw, a drill or the like.

The machining table 10 comprises a cover plate 11 (reference element). In the area of the cover plate 11, several clamping elements 20 are arranged in a matrix form. In other words, clamping elements are provided adjacent to one another in a longitudinal direction and in a width direction of the machining table 10. The longitudinal direction and the width direction according to the embodiment described here thereby define the x-y plane.

As explained below, the clamping elements 20 can each be controlled individually and, on the one hand, can be used to hold and optionally clamp a workpiece, and on the other hand, can serve to form a compressed air film in the area of the respectively controlled clamping elements.

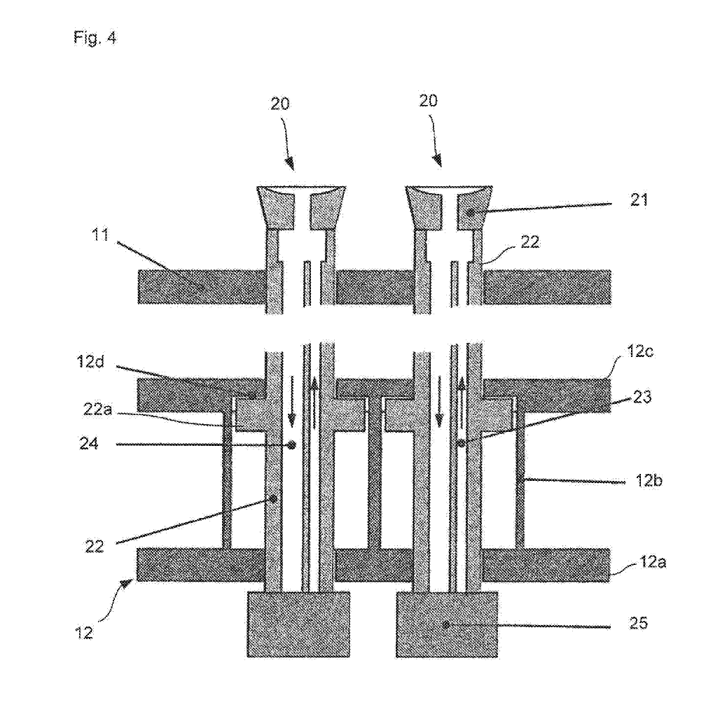

In the following, the configuration and the mode of operation of the clamping elements 20 are firstly described with reference to FIG. 4.

A clamping element 20 comprises a suction pad 21. The suction pad 21 is carried by a tubular support element 22. The support element 22 extends through an opening in the cover plate 11 of the machining table 10. Furthermore, the support element 22 extends through openings of a holding frame 12 which is inside the machining table 10.

The holding frame 12 comprises a first section 12a as well as a second section 12c spaced from the first section 12a by struts 12b.

The tubular support element 22 comprises a projection 22a which has a larger circumference than adjacent sections of the support element 22, and which is arranged within the holding frame 12. Consequently, the projection 22a of the support element 22 can be guided in a pushing-out movement (the extended state of the support element is shown in FIG. 4) against a stop 12d of the holding frame 12 so that a locking of the support element relative to the holding frame 12 can be carried out at this location.

Various mechanisms for locking the support element 22 in the extended state are to be mentioned. On the one hand, the locking mechanism can be carried out by means of a latch connection. Furthermore, it is possible to insert one or more pins into an area of the projection 22a. It is further possible to form a gripping mechanism within the holding frame 12, which engages as soon as the projection 22a of the support element 22 is moved against the stop 12a of the holding frame.

A compressed air channel 23 as well as a vacuum channel 24 are provided within the support element 22. If necessary, a negative pressure (vacuum) or a positive pressure (compressed air) can consequently be applied to the suction pad 21. By applying vacuum, a workpiece is clamped against the suction pad. By introducing compressed air over the compressed air channel 23, a workpiece which is in the area of the corresponding clamping element 20, can be spaced apart from it by a minimal compressed air film. In this manner, it is possible to relatively easily remove a previously clamped workpiece from the corresponding clamping element 20 and, with a large-area compressed air film being formed, to allow the workpiece to slide over the suction pad 21 of the clamping element 20. It is also possible to remove chips or the like from the corresponding suction plate by blowing out compressed air.

A separate drive 25 is provided for each clamping element 20, which is only shown schematically in the embodiment shown in FIG. 4. The drive is used to move a respective clamping element 20 in a vertical direction.

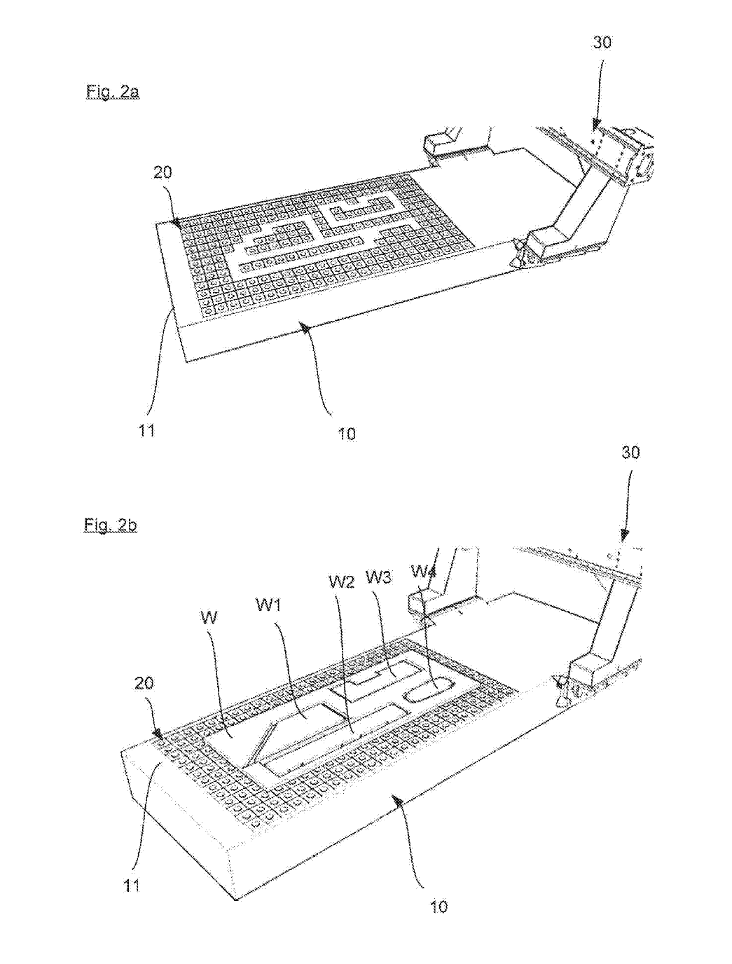

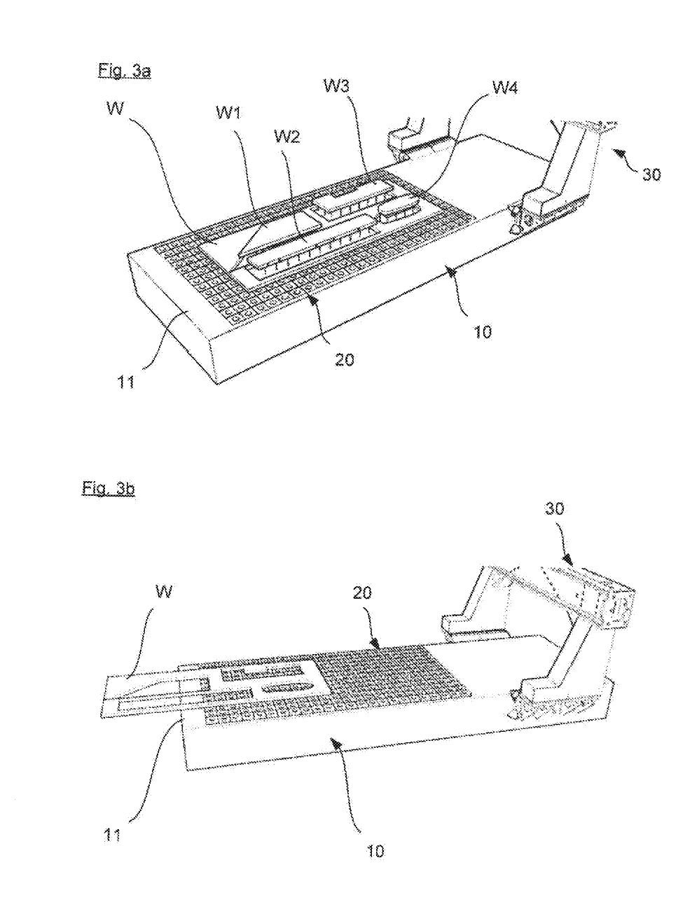

To illustrate the mode of operation, reference is made below to FIGS. 2a, 2b, 3a, 3b.

In particular, an initial workpiece is firstly placed on the machining table 10. If compressed air is supplied through the pressure channel 23 to the suction pad 21, the workpiece can therefore be moved relatively easily over the corresponding clamping elements 20 and consequently can be aligned. The workpiece is subsequently clamped by the creation of a negative pressure at suction pads 21 of certain clamping elements 20 that are in contact with the workpiece.

Furthermore, several clamping elements 20 are moved downwards in a vertical direction (see FIG. 2a), so that a machining tool can separate partial workpieces from the initial workpiece. For illustration, the initial workpiece is not shown in FIG. 2a. Rather, the clamping elements 20 which are adjusted in a vertical direction downwards are shown, which essentially correspond to the contours of the partial workpieces that are to be separated out. In FIG. 2b, the separated partial workpieces W1-W4 as well as the remaining workpiece W are shown.

Subsequently, the separated workpieces W1-W4 are moved upwards in a vertical direction by a pushing-out movement of the clamping elements 20 upon which the corresponding workpieces W1-W4 are situated (FIG. 3a). The pushing-out movement can be carried out individually or in groups since the clamping elements 20 are individually controllable. Consequently, it is possible to machine, for example, the area of the narrow sides of the workpiece W1-W4, in particular to provide them with bore holes.

Moreover, it is possible according to one modification, to adjust the clamping elements during the machining, in order to produce in this manner a (optionally additional) relative movement between the corresponding workpiece W1-W4 and a (stationary or moving) tool.

After the machining has been carried out, the workpieces W1-W4 can be removed, for example, manually or even mechanically after the vacuum on the clamping elements 20 holding the workpieces has been released and consequently the holding force is released. For this, it is advantageous that the workpieces W1-W4 are in a position that is raised over the cover plate 11 due to the extended position of the respective clamping elements 20.

Subsequently, the previously lifted clamping elements 20 are driven back to their initial position. In the retracted position, compressed air can now be blown out at a plurality of clamping elements 20 in order to guide the remaining workpiece W (see FIG. 3b) in a sliding manner over the plurality of the clamping elements 20 and to consequently remove it from the machining table 10.

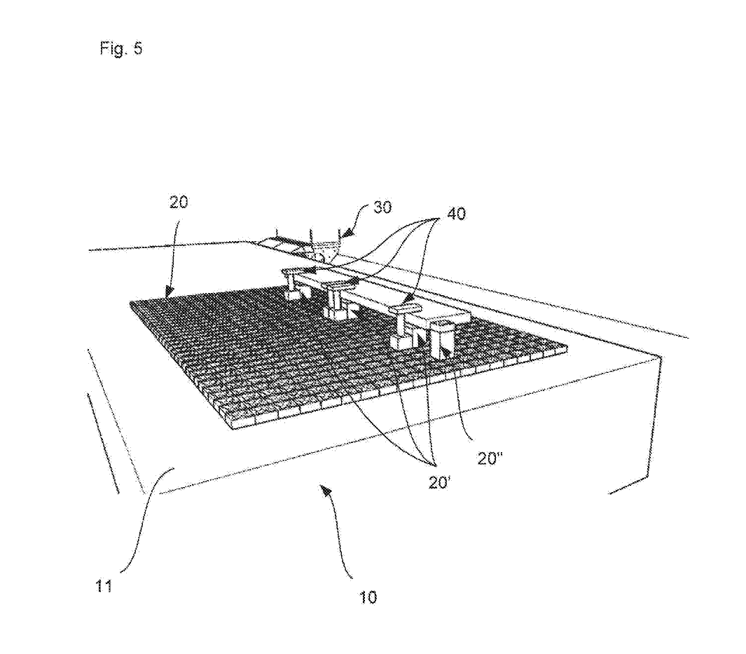

Although it has been described according to the present embodiment that the clamping elements 20 are used as a support for workpieces, it is also possible to use one or more clamping elements 20 as a stop for a workpiece (described in more detail below in connection with the embodiment shown in FIG. 5). For this, the clamping element 20 which is supposed to function as a stop, is adjusted higher than a further clamping element (or clamping elements) which is used as a support for a workpiece.

According to one modification of the described embodiment, a sheet is provided above the clamping elements 20 which is in contact with the areas of the suction pad 21. Openings are provided in the area of the suction pad 21 so that the function of clamping workpieces can be carried out as described above. Furthermore, the sheet is elastic so that the clamping elements are able to be moved. However, the interspaces between the clamping elements 20 are sealed to a certain extent so that chips cannot fall into this area.

FIG. 5 shows a further embodiment of the present invention. In addition to the clamping elements 20 that are in a shared position, clamping elements 20′ are shown which in a raised position serve as a support for a workpiece W′. A negative pressure/vacuum is applied on the suction pads of the clamping elements 20′ in order to hold the workpiece W′. However, it is also alternatively possible that the suction pads of the clamping elements 20′ only serve as a support (without negative pressure/vacuum).

Furthermore, a further clamping element 20″ is extended further, in comparison to the clamping elements 20′. Consequently, the clamping element 20″, in particular a lateral surface of a clamping element 20″, can serve as a stop for the workpiece W′. In other words, the workpiece W′ is placed on the clamping elements 20′ and aligned with the clamping element 20″. For machining the workpiece W′, the clamping element 20″ can be moved back into a position corresponding to the remaining clamping elements 20.

There are clamping units 40 that are adjacent to the clamping elements 20′ upon which the workpiece W′ is placed. The clamping units are preferably mounted on clamping devices, in particular suction pads, of clamping elements. The clamping units 40 each comprise a piston rod which extends in a vertical direction, and an engagement element which starting from the piston rod extends over an upper side of the adjacent clamping element 20′. The piston rod and the engagement element are movable in a vertical direction.

The clamping units 40, in particular the piston rod and the engagement element, can be operated by means of their own drive unit. However, it is preferred in the present embodiment that the clamping units 40 are moved by means of a negative pressure which can be introduced into them by means of the clamping element 20 arranged beneath the respective clamping unit 40.

One possible method sequence in the embodiment shown in FIG. 5 is as follows: Firstly, the workpiece W′ is placed on the clamping elements 20′ which are in the receiving position or in a raised position. During or after the placement of the workpiece W′ on the clamping elements 20′, it is aligned to the clamping element 20″. Subsequently, the clamping units 40 are actuated in order to press the workpiece W′ against the clamping elements 20′.

The clamping units 40 can be positioned manually or by means of a device adjacent to the clamping elements 20′. The positioning of the clamping units 40 can occur before or after the placement of the workpiece on the clamping elements 20′.

1. A machining table for a machining device, comprising:
a reference element; and
plural clamping elements which each have a clamping device,
wherein the clamping elements are able to be raised starting from a receiving position relative to the reference element into a raised position and lowered into a lowered position.

2. The machining table according to claim 1, wherein the clamping elements are individually controllable in order to carry out an adjustment movement of the clamping element relative to the reference element.

3. The machining table according to claim 1, wherein the clamping elements are infinitely adjustable.

4. The machining table according to claim 1, wherein a drive is provided for each clamping element in order to carry out an adjustment movement of the clamping element, relative to the reference element.

5. The machining table according to claim 1, wherein the clamping devices of the clamping elements are held by a support element, the support element extending through an opening in the reference element of the machining table.

6. The machining table according to claim 5, wherein the support element is movable into an upper and a lower end position.

7. The machining table according to claim 5, wherein the support element has a projection, the projection in a raised position of the clamping element can be moved against a stop of a holding frame of the machining table and/or the projection in a lower position of the clamping element can be moved to an upper side of the first section of a holding frame of the machining table.

8. The machining table according to claim 1, wherein the machining table has a locking mechanism for each clamping element, in order to lock the respective clamping element into a position.

9. The machining table according to claim 1, wherein the machining table has a negative pressure source or a negative pressure connector and a compressed air source or a compressed air connection, which are correspondingly connected with a negative pressure channel or a compressed air channel of a clamping element.

10. The machining table according to claim 1, wherein the clamping elements are arranged matrix-like in a plan view of the machining table.

11. The machining table according to claim 1, wherein above the clamping elements a sheet is provided which has openings in the area of the clamping devices.

12. The machining table according to claim 1, further comprising:
at least one clamping unit mounted on a clamping device of a clamping element.

13. A machining device for machining workpieces, with a machining table according to claim 1 as well at least one machining aggregate, for machining the workpieces.

14. A method for machining a workpiece using a device according to claim 13, comprising:
placing a workpiece in the area of a first and a second clamping device of a clamping element from a plurality of clamping elements, and holding the workpiece with the first clamping device;
moving the second clamping device in a lowered position; and
separating at least one partial workpiece from the workpiece.

15. The method according to claim 14, further comprising the step:
moving the first and/or a further clamping element into a raised position in order to raise a separated partial workpiece.

16. The method according to claim 14, further comprising the step:
locking the raised clamping element in the raised or lowered position.

17. The method according to claim 15, further comprising the steps:
removing the partial workpiece from the at least one raised clamping element; lowering the raised clamping element; and
applying a positive pressure to the plurality of clamping units, in order to remove a remaining workpiece.

18. The method according to claim 15, a machining of a narrow side of the partial workpiece being carried out in the raised position of the raised clamping element.

19. The machining table according to claim 2, wherein the adjustment movement of the clamping element is in a vertical direction relative to the reference element.

20. The machining table according to claim 4, wherein the adjustment movement of the clamping element is in a vertical direction relative to the reference element.

21. The machining table according to claim 5, wherein the support element is tubular.

22. The machining table according to claim 7, wherein the holding frame is arranged in a vertical direction beneath the reference element.

23. The machining table according to claim 12, wherein the clamping device onto which the at least one clamping unit is mounted is a suction pad of the clamping element.

24. The machining device according to claim 13, wherein the workpieces are plate-shaped.

25. The machining device according to claim 13, further comprising:
a movable unit that is movable relative to the machining table, the movable unit accommodating the machining aggregate.

26. The machining device according to claim 25, wherein the movable unit comprises a side-arm, a portal or an articulated arm robot.

27. The method according to claim 14, wherein the workpiece is plate-shaped.

28. The method according to claim 14, wherein at least one of the first clamping device or the second clamping device is a suction pad.

29. The method according to claim 14, wherein the second clamping device is moved in the vertical direction.

30. The method according to claim 15, wherein the first or the further clamping element is moved in the vertical direction.

31. The method according to claim 16, wherein the raised clamping element is locked in the raised or lowered position by a positive or non-positive connection.
